(19) United States
(12) Patent Application Publication
(10) Pub. No.: US 2025/0170021 A1
(43) Pub. Date: May 29, 2025

(54) SYSTEMS AND METHODS FOR TEMPERATURE CONTROLLED BIOLOGICS STORAGE, DELIVERY, INTEGRITY, AND SECURITY

(71) Applicant: Legacy Innovation Inc., Boise, ID (US)

(72) Inventors: Jeffrey Travis Dalton, Boise, ID (US); Kim Marie Reeves, Boise, ID (US); William Mack Buchanan, Boise, ID (US)

(21) Appl. No.: 18/912,325

(22) Filed: Oct. 10, 2024

Related U.S. Application Data
(60) Provisional application No. 63/518,808, filed on Aug. 10, 2023.
(60) Provisional application No. 63/602,990, filed on Nov. 27, 2023.

(51) Int. Cl. A61J 1/16; A61J 1/10; F25B 21/04; F25B 49/00

(52) U.S. Cl. CPC A61J 1/165; A61J 1/10; F25B 21/04; F25B 49/005; A61J 2200/44; A61J 2200/72; A61J 2205/60

(57) ABSTRACT

System and methods for temperature-controlled biologics storage, delivery, integrity, and security. Embodiments include a temperature-controlled storage device with a lid portion configured to securely close the temperature-controlled storage device when closed and provide access to an interior portion of the temperature-controlled storage device when opened, a thermoelectric cooling plate, and a biologic bag sensor. Embodiments also include a biologic bag configured to selectively store and dispense a biologic substance and a smart label including a tunable temperature sensor, a read-write recorder capable of delivering power to the tunable temperature sensor and configured to acquire temperature readings from the biologic bag and maintain a data log, and wherein the temperature-controlled storage device is configured to adjust the temperature of the thermoelectric cooling plate based on communication from the tunable temperature sensor.

### CROSS-REFERENCE TO RELATED APPLICATIONS

This application, under 35 U.S.C. § 119, claims the benefit of U.S. Provisional Patent Application Ser. No. 63/518,808 filed on Aug. 10, 2023, and entitled “Thermoflume,” and U.S. Provisional Patent Application Ser. No. 63/602,990 filed on Nov. 27, 2023, and entitled “Thermoelectric Device, Methods, and BLIS,” the contents of which are hereby incorporated by reference herein.

### FIELD OF THE DISCLOSURE

This disclosure relates generally to systems and methods for temperature-controlled package storage, delivery, integrity, and security. In particular, this disclosure relates to systems and methods for temperature-controlled package storage, delivery, integrity, and security for blood and other biologics.

### BACKGROUND

Biologics, such as blood, blood components, tissues, organs, and the like (herein collectively referred to as “biologics”) are not currently stored and transported with real-time, verifiable temperature control. Current delivery methods are slow and inefficient, which can compromise product efficacy and patient outcomes. Deliveries of biologics to disaster areas and Chemical, Biological, Radiological, Nuclear, and high yield Explosives (“CBRNE”) events are at risk of contamination. All this contributes to a lack of mobility and accessibility in the national biologics and blood supply chain, which prevents informed and proactive resource management and leads to underutilization available biologics and a staggering discard rate.

For example, existing systems and methods lack real-time, verifiable temperature control in storage and delivery containers that jeopardizes the integrity of blood and biologics and contributes to high discard rates.

Traditional biologics storage and transport containers (e.g. standard refrigeration, Collins Box, Golden Hour Box, or other cooler using wet/dry ice and/or phase change material with temperature sensor) do not continuously adjust the internal temperature of the container based on the needs of the biologics stored within.

Failure to maintain the indicated temperature range of sensitive biologics puts at risk efficacy, potency, and viability, which introduces uncertainty into the supply chain. (e.g. Did the biologic ever go out of temperature range? Can you prove it did not?). Biologics in question must be discarded.

Current storage and delivery methods are not capable of warming biologics enroute for immediate use (e.g. transfusing blood at the point of injury).

Existing delivery methods for biologics like blood and vaccines are slow and inefficient, potentially compromising product efficacy and causing spoilage.

Traditional ground delivery struggles to reach remote locations or crisis areas quickly and efficiently. Debris, obstacles, and hazardous terrain can impede movement, delaying critical treatment and causing time-sensitive biologics like blood and vaccines to degrade (due to temperature excursion) or even expire.

Air assets often lack payload capacity for critical medical supplies, hampering timely delivery and resulting in prolonged casualty treatment times, increased mortality rates, and overwhelmed field medics. See, e.g., “CBRN Medical Response: Challenges and Considerations” by Michael J. Isenberg et al. (2016) in Disaster Medicine and Public Health Preparedness.

CBRNE incidents and mass casualty events present unique logistical and safety challenges due to widespread contamination. Traditional CBRNE response primarily relies on ground vehicles, exposing the vehicles and personnel to contamination. Existing drone technology for medical supply delivery in disaster zones often falls short due to limited payload capacity and insufficient range. Likewise, a lack of radiation shielding or radiation hardened electronics puts at risk the storage device itself and contaminates the biologics stored within.

Blood transfusions during a CBRNE event are complex. There is currently no commercially available blood transfusion tubing that is specifically rated for use in CBRNE incidents.

Further, there is a lack of overall mobility, and hence availability and accessibility, within the national blood supply. For example, on average, the US has a 2.5 day blood supply and Canada has a 10 day supply; however much is discarded due to temperature excursion and expiration dates.

At EMS World Expo in September 2023, the Fire Chief of Palm County, Florida, stated that of the 79 units of Low Titer 0+ Whole Blood (LTOWB) he put on first responder vehicles, 67 were discarded based on expiration date, 7 were discarded based on temperature excursion, and only 5 were actually transfused. This is a 94% discard rate.

At the MTEC Blood and Blood Products State of the Technology Meeting in November 2023, Dr. John Holcomb shared that the American Red Cross and America's Blood Centers discarded 2 million units of blood in 2022 alone. (2 million units×˜$500/unit=$1 billion).

Problems are also created by the lack of returnability of biologics. For example, once blood leaves a US Blood Supply System facility, there is no universally accepted temperature monitoring and control system to detect and prevent temperature excursion. As blood integrity cannot be guaranteed, this prevents universal return privileges and unused blood must be discarded rather than returned. Blood supply reserves are quantified and managed by region. Logistics for blood, blood products, and to an extent biologics, is largely based on locale and historic contracting with local hospitals.

Issues also exist with current disincentivized mobility of biologics. For example, blood donation centers like the American Red Cross and American Blood Centers get reimbursed by insurance companies only when donated blood is used in transfusions. They don't get paid for blood simply collected and added to the supply. The unintended financial motivation is to let blood expire and discard it, rather than ship it to where it is needed. The current reimbursement system hinders the efficient distribution of blood across the country to satisfy ongoing supply and demand.

Furthermore, disasters can cause a sudden surge in blood demand and lack of effective distribution might jeopardize patient care during these crises. There exists a lack of continuous real-time data and inventory tracking throughout the entire blood/blood product journey from donor to recipient.

Risks also exist of expired blood accidentally entering the national blood supply (e.g., Thermochromatic ink labels can be compromised during handling or transport resulting in false positives.).

The above, and other issues, prevents informed decision-making in creating policy and applying predictive modeling to streamline logistics for transport and delivery and prevents valuable research from being performed from data gathered during blood and biologics journey from donor to recipient, which could be analyzed to improve patient outcomes.

Additionally, problems arise with outdated biologic storage and transportation methods. For example, the military's methods for storing and transporting blood have remained unchanged since the 1960s. Currently, blood is stored in a Collins Box; a cardboard box lined with a styrofoam cooler that is filled with either a 9 lb bag of ice, six scoops of dry ice, or gel packs. The Collins Box is the only validated storage method for the entire blood delivery process: collection to frontline delivery via aircraft drops. However, it has limitations in terms of storage capacity and temperature distribution. The Food and Drug Administration (FDA) requires blood to be transported in an environment that maintains a continuously cooling temperature range of 1-10° C. This packaging method restricts the shelf life of blood and blood products to a maximum of eight hours which is undesirable. The Collins Box also has a limited use life span as it's a cardboard box that can only be used a few times and must be discarded.

Typically, in the military theater, ensuring blood availability throughout the supply chain to the front lines requires a large logistical footprint and incurs significant wastage. Fluctuations in temperature and structural instability of the Collins box (e.g., breakage, leakage) risks damage to the blood bags, rendering them useless. For example, in 2021, United States Central Command (CENTCOM) spent $3,100,000 to pre-position blood products but only transfused $287,000 worth, which amounts to a significant wastage of $2,813,000. Although no formal study or data collection has been conducted on wastage, some commands spend about $100,000 quarterly on Collins Boxes ($400 each), and there are a total of eight Armed Services Blood Bank commands. Dry ice, which is also separately accounted for, costs an average of $28,000 per command annually.

Current systems and methods of drone (i.e., unmanned aerial vehicles or UAVs) delivery also have issues. For example, one main technological challenge is maintaining consistent blood temperatures inside drone payloads across various altitudes and ambient conditions for extended periods, while minimizing power consumption. Moreover, in the theater of operations, regular distribution to forward operating bases involves aircraft and often requires convoys or pickup trucks to travel through high-risk areas for 2-3 hours. During emergencies, helicopters are deployed, risking personnel due to the craft's visibility and noise. Concerns also exist that future conflicts against formidable adversaries could make delivering blood via medevac helicopters more challenging. This situation may require injured thus troops to remain on the frontlines for days, in need of blood transfusions and critical medical care. The current methods of delivering blood to injured warfighters, particularly in regions where the US military lacks air superiority, perpetuate these risks and challenges.

The Joint medical community explored the use of autonomous UAVs for medical care capability, specifically focusing on UAVs for blood delivery due to blood's unique constraints and finite shelf life. The precise temperature-controlled device aims to address this issue by being combined with (for example, attaching to) a UAV to potentially air drop or land, delivering blood, as close as possible to wounded soldiers on the battlefield without endangering other airframes containing pilots.

One study, comparing blood product delivery by UAVs versus traditional ground methods, revealed that using UAVs for blood product delivery resulted in shorter delivery times and fewer product expirations, particularly in remote or challenging geographic areas where air superiority is limited. Drone delivery improved timely access to blood products with a median delivery time of 19 minutes compared to 60 minutes for ground delivery. However, maintaining the temperature of blood units during drone transportation remains a significant challenge.

In the civilian healthcare and emergency services sector, efforts are underway to integrate drone delivery, as it has shown promise in providing faster emergency care globally. Another study found that using drones for emergency medicine delivery led to an average time savings of 14 minutes in reaching remote areas. This efficient and rapid access to healthcare could benefit rural areas in the US and other jurisdictions, addressing disparities in health services and ultimately improving health outcomes.

Additionally, studies have shown that hemorrhage is the leading cause of death in combat casualties with potentially survivable injuries. One study analyzed 81 fatalities between 2002-2009 and found that hemorrhage was the cause of death in 81.5% of the cases. These fatalities occurred before reaching a medical facility, highlighting the urgent need for available blood products for transfusion on the battlefield or in a pre-hospital setting.

Evidence supports that early blood product administration saves lives on the battlefield. Whole blood, whether cold-stored or fresh, outperforms component therapy. The Joint Trauma System, Defense Committee on Trauma, and the Armed Services Blood Program published a consensus statement on whole blood endorsing the following: “1) whole blood should be used to treat hemorrhagic shock; 2) low-titer group O whole blood is the resuscitation product of choice for the treatment of hemorrhagic shock for all casualties at all roles of care; 3) whole blood should be available within 30 min of casualty wounding, on all medical evacuation platforms, and at all resuscitation and surgical team locations; and 4) when whole blood is not available, component therapy should be available within 30 min of casualty wounding”. The production of low-titer O whole blood (LTOWB) can greatly aid in damage-control resuscitation for patients in hemorrhagic shock on the battlefield. Whole blood is simpler logistically to position far forward on the battlefield than blood components such as platelets and frozen plasma.

Beyond the military, carrying blood on ambulances for prehospital use would change the civilian standard of care. Currently, only about 1% of emergency medical services (EMS) departments in the country carry blood. Traumatic injuries account for approximately 5,000,000 deaths annually, with around 30% caused by blood loss. More than half of trauma-related blood loss fatalities occurred in the prehospital setting.

Evidence suggests that prehospital blood transfusion significantly decreases trauma patient mortality rates leading to improved patient outcomes. EMS has pivoted from a “scoop and run” system to a “stay and play” system by building resuscitation interventions at or near the patient to improve prehospital, lifesaving treatment. This includes the early use of LTOWB as an essential life-saving treatment modality.

Further, because blood products are stored at low temperatures, blood is often transfused cold in emergencies. Cold blood transfusions can worsen patient care by lowering core body temperature, increasing the risks of hypothermia which can lead to wound infection, platelet dysfunction, and heart complications. The delay in obtaining warm blood also delays the life-saving transfusion. The arrival of prewarmed blood prevents (at least reduces) the on-target need for additional fluid-warming devices that are generally bulky and have poor battery life, which is a major problem during prolonged field care scenarios.

One study on 20,000 combat casualties and found that hypothermia, even a single recorded lower temperature, was linked to worse outcomes. It has been noted that even moderate hypothermia (35° C.) affects platelet activity, leading to increased bleeding and a greater need for blood transfusion. With the growing focus on cold environment warfare, preventing hypothermia becomes crucial, which includes keeping intravenous fluids and blood from freezing.

Other drawbacks, issues, inconveniences, inefficiencies, and problems with current systems and methods also exist.

### SUMMARY

Accordingly, disclosed embodiments address the above, and other, drawbacks, issues, inconveniences, inefficiencies, and problems with current systems and methods.

Disclosed embodiments include Biologics Logistics Integrity and Security (BLIS) systems and methods. BLIS tackles the weak links in the national blood and biologic supply chain to prevent wasted donations and improve accessibility. This ecosystem uses advanced technology to guarantee blood integrity throughout the journey from donor to recipient. Serving both civilian and military needs, it optimizes logistics, conserves resources, and builds a solid data foundation for research and planning.

By utilizing next-generation temperature-controlled containers and real-time data tracking, BLIS revolutionizes storage and delivery for blood, blood products, and biologics in routine scenarios, emergencies, mass casualties, and CBRNE events. Importantly, it integrates seamlessly with existing delivery systems, leveraging both traditional and emerging technologies in advanced operations and multi-capability drones for a truly comprehensive solution.

Embodiments of BLIS Containers include Next Generation Storage and Delivery for Biologics. BLIS containers are purpose-designed, lightweight, modular, stackable, rugged, hermetically sealed, and reusable containers that function as mobile blood banks for storage and intermodal delivery (e.g. vehicle, drone, or medic) of blood and biologics. Embodiments employ open architecture and interoperability for communication protocols and payload integration into a drone or first responder vehicle. Embodiments may be powered by battery and/or connected to the onboard power system of a drone or first responder vehicle. Embodiments include precise temperature control and real-time monitoring that maintains optimal temperature of biologics throughout storage and transport by incorporating thermoelectric adaptive temperature management technology, diode heat pipe technology, and embedded temperature sensor labels. Embodiments are capable of warming blood and blood products enroute for immediate transfusion on arrival.

Disclosed embodiments also included features designed specifically for CBRNE events. For example, an outer shell of the BLIS Box is composed of advanced materials which allow for decontamination during most CBRNE incidents. Embodiments may include airtight and watertight seals and advanced insulated materials like fluorine-intercalated biochar to protect contents from harmful radiation, chemical, biological, and other contaminants, ensuring product integrity and efficacy despite hazardous conditions.

Embodiments include the ability to transfuse blood and blood products directly from a BLIS Box without exposing the biologics to the atmosphere reduces risk of site contamination and exposure. Currently, there is no commercially available blood transfusion tubing that is specifically rated for CBRN incidents.

Embodiments of the disclosed BLIS System also include Temperature Control and Data Tracking & Logging. Embodiments provide BLIS Blood Tags with Read/Write Capability. In some embodiments, a BLIS Blood Tag is an auxiliary label adhered to blood bags and/or biologics packaging on the opposite side of the FDA required label and using the same label adhesive. In some embodiments a BLIS Blood Tag contains an embedded temperature sensor with read/write memory capability that functions as a thermostat for real-time temperature monitoring and precise temperature control to ensure product integrity and potentially extend shelf life. Firmware embedded into each temperature sensor defines the prescribed temperature parameters for blood, blood products, or biologics.

Disclosed embodiments also include BLIS Data Tracking & Logging. BLIS systems use robust data platforms to integrate temperature sensor data with GPS location and delivery route information, providing real-time tracking and insights into biologic status throughout the entire journey from donor to recipient. Embodiments enable near-constant collection of read/write data that can be used to control the interior environment of each BLIS Box to ongoingly adjust the temperature to keep the blood, blood product, or biologic within the prescribed temperature parameter. Embodiments may also use self-learning algorithms to predict and proactively manage temperature fluctuations. The data collection, storage, and access are HIPAA compliant and available to healthcare providers and emergency responders, empowering proactive interventions and improved resource management. Embodiments of BLIS data can facilitate predictive modeling and decision-making for research purposes and logistics planning to better inform treatment of pre-hospital injuries and improve patient outcomes. Additional outcomes include the ability to align data from blood donors with blood recipients, which may generate new insights in blood research. For example, blood from donors who exercise prior to donating may have increased total Hb and red cell mass, which could enhance oxygen-carrying capacity in recipients.

Embodiments of BLIS also may incorporate BATDOK, a multi-patient, point of injury, casualty tool that is designed to improve how combat medics deliver care in austere environments using an adaptable smartphone program. As will be apparent to those of skill in the art having the benefit of this disclosure, the herein disclosed data-driven approach to logistics planning can better support disaster and emergency needs. Optimized storage and delivery of our national blood supply will protect quality, and reduce waste, which ultimately results in more mobile, available, and accessible blood supply in times of need.

Also disclosed is a precise temperature-controlled device that interacts with packaging temperature sensors. Embodiments include a precise temperature-controlled storage device that regulates, monitors and adjusts temperature settings based on the temperature control requirement of the content(s) it stores while in transit or held at a specific location.

For example, in some embodiments an algorithm AI model may ascertain the data and process the data and transmit a signal to change conditions in response to the processed data. More particularly, a temperature sensor may record an external temperature (environmental/ambient temperature outside the device and/or packaging), may record an internal temperature (temperature inside the device and/or packaging), may record the energy power consumption of the device, and this recorded data may be received by the algorithm (processor) to process the data to generate an output for altering the conditions/temperature of the device to ultimately manipulate and control the temperature of the contents of the packaging to a desired target temperature falling within a desired and/or prescribed range, for instance.

Embodiments of the AI model may be capable of real-time learning functionality to improve the efficiencies of the device such that the power usage of the device to heat and/or cool the contents/packaging to a desired level is commensurate with the distance to be travelled by the device (for delivery by a drone, for example). The AI model may be able to determine the remaining battery life of the device to maintain the contents at a certain temperature, and thus could alert users of the expiry of the contents based on the distance to be traveled. For example, if blood is being transported, the AI model may be able to accurately generate the optimal power to heat/cool ratio to preserve the contents for as long as possible. Such an AI model may thus provide to a healthcare professional the estimated time of expiry of the blood based on remaining battery life, for instance. The AI model may thus monitor, regulate, and/or adjust the battery power of the device (and optionally a drone). An AI model offers the benefit of being a learning model. Hence, more use of the device comprising the AI model (knowledge-based model) will improve efficacy and efficiencies of the device as the AI model learns how to adjust optimally based on environmental conditions it experiences.

In some embodiments the temperature sensor(s) may be adhered to the content(s)′ packaging or may be designed into a label that can be adhered to the content(s)′ packaging. In some embodiments, the label is a smart label. Such a smart label may comprise a chip that can store information electronically. The chip may not require its own power source. The chip may be powered by an external source, such as a smart label reader (a Near Field Communication (NFC) reader, for example). The smart label may be printable. The smart label may be flexible. The smart label may be able to store and capture information up to any amount of times. In other words, the smart label may be able to store 40000 temperature readings, for example. From these data points (40000) a temperature profile, history, log, and charts may be accessed and/or generated on a visual display for a user. This may facilitate verification on the integrity of the contents of the device. For example, the temperature profile of blood in a blood bag (having a smart label attached/adhered thereto) may confirm that the temperature of the blood was maintained within an acceptable range throughout its delivery to the destination and is thus safe for administration to a patient upon delivery.

If, for example, the contents in the precise temperature-controlled storage device are two units of low-titer O+ whole blood, and each unit of the blood was contained in a respective bag, each blood bag label is capable of providing an on-demand temperature reading and/or a temperature reading at desired intervals which can be selected by the user if desired (e.g. every 2.5 minutes). Data logging technology creates an ongoing temperature manifest on each sensor for each unit of blood so that the temperature of each unit of blood can be adjusted in response to the environment (for instance, change in external temperature, humidity, and/or diurnal cycle). The controller's algorithm/unique AI modeling is capable of utilizing each temperature reading by having the ability to adjust the temperature applied to, for example, copper plates (or other thermally conductive material and shape) that are in direct contact with each unit of blood (for instance, blood bag). Increasing or decreasing the copper plate temperature will cause the temperature of each unit of blood to either rise or fall within a prescribed temperature range. Low-titer O+ whole blood may be stored between 1-6° C., for instance. It is generally accepted that blood temperatures outside these parameters would no longer be considered suitable for storage in the mobile blood bank. Instead, the blood would be considered “out-of-the-blood-bank” requiring that the blood be used over the following 6-8 hours after the out-of-the-blood-bank event or destroyed. In the above example, embodiments of the device also have the ability to warm the low-titer O+ whole blood to ˜ 38° C. for transfusion.

Embodiments of the precise temperature-controlled device are intricately connected to the continuous or close-to-continuous temperature monitoring of the blood it contains. The device maintains the state of the blood contained therein to a pre-determined, target, and/or desired state. For example, a storage temperature of 1-6° C. or transfusion temperature up to 38° C. may be the pre-determined, target, and/or desired state. In other words, the precise temperature-controlled device may be responsive to the ongoing temperature monitoring of the blood contained therein and the desired state of that contained blood: for instance, a storage temperature of 1-6° C.; or a transfusion temperature of up to 38° C. Enroute (during transit, for example) temperature may be calculated by the controller to determine the optimal time to begin to warm the blood to 38° C. for transfusion. If the delivery time does not allow for the device to completely warm the blood to transfusion temperature, warming enroute to ˜20 to 30° C. would lessen the work/battery required to “trim” temperature to 38° C. for transfusion by a standard field blood warming device, since the blood would at least be warmed closer to the 38° C. target temperature on delivery.

Disclosed embodiments also include additional data tracking capabilities as follows. When utilizing a “Walking Blood Bank” blood collection strategy (i.e., drawing blood from soldiers when it is needed), each unit of blood may be coded with the donor's unique identifier, time and date stamped, then put into the precise temperature-controlled device to reduce the temperature to 1-6° C., and begin to hold at that temperature until needed. Rather than relying on the device's battery, the precise temperature-controlled device may utilize an auxiliary power source, thereby maintaining battery life at full capacity.

When blood is needed, the device may be transited by being packed in a medic's rucksack, for example, put into a first responder vehicle, or carried by a drone to the point of injury. A recipient in need of the blood, such as a soldier who is wounded for instance, receives the transfusion with 38° C. blood (a target temperature, for instance), and the temperature sensor attached to the blood bag may then be peeled off the bag and adhered to the wounded soldier. This accomplishes two things: (1) it ties the donor data to the patient data to ascertain results for scientific research purposes, and (2) it provides a fast and efficient way to take the patient's body temperature using the temperature sensor and a hand-held device.

Embodiments of the disclosed precise temperature-controlled device may be utilized as a mobile cooling and warming blood bank, for example. The temperature-controlled device also has applications in preserving, for instance, organs, tissue, vaccines, medicines, or any other temperature-sensitive contents that need to be transported.

Embodiments also include a precise temperature-controlled device cooling and warming blood bank that is a solution for problems normally encountered in preserving blood integrity during military transport. Using thermoelectric temperature regulation, the precise temperature-controlled device ensures consistent and accurate blood temperature throughout distribution, conserving valuable resources. Its drone attachment capability reduces the logistical footprint for urgent patient care in far-forward and/or austere environments.

When coordinating routine and emergency blood distribution between the staging facility and the requesting operation base, it is important to consider the challenges posed by hazardous or hard-to-reach areas in far-forward environments. In such areas, it is challenging to distribute, transport, and deliver blood, particularly in areas where the United States does not have air superiority. This limits transportation options in harsh or high-risk territories. The precise temperature-controlled device disclosed herein also has the ability to be attached/equipped to drones at least for: delivering blood to combat wounded where prehospital, life-saving transfusion is critical; providing transfusion-ready, whole blood with no extra warming efforts by the Combat Critical Care (C3) providers for faster and enhanced care; and mitigating risk to military service members involved in the blood supply chain.

Other embodiments also exist.

### BRIEF DESCRIPTION OF THE DRAWINGS

FIG. 1 shows a schematic perspective view of a precise temperature-controlled storage device in accordance with disclosed embodiments.

FIG. 2 shows a schematic perspective view of a precise temperature-controlled storage device in accordance with disclosed embodiments.

FIG. 3 shows a schematic perspective view of a precise temperature-controlled storage device in accordance with disclosed embodiments.

FIG. 4 shows a schematic perspective view of a precise temperature-controlled storage device in accordance with disclosed embodiments.

FIG. 5 shows a schematic perspective view of a precise temperature-controlled storage device in accordance with disclosed embodiments.

FIG. 6 shows a plan view of a precise temperature-controlled storage device in accordance with disclosed embodiments.

FIG. 7 shows a schematic perspective view of a precise temperature-controlled storage device in accordance with disclosed embodiments.

FIG. 8 shows a schematic perspective view of a smart blood bag in accordance with disclosed embodiments.

FIG. 9A shows a schematic top perspective view of an assembly of a precise temperature-controlled storage device and a drone in accordance with disclosed embodiments.

FIG. 9B shows a schematic bottom perspective view of an assembly of a precise temperature-controlled storage device and a drone in accordance with disclosed embodiments.

FIG. 10 is a schematic illustration of radiant forced air cooling in accordance with disclosed embodiments.

FIG. 11 is a schematic illustration of conduction cooling in accordance with disclosed embodiments.

FIG. 12 is a schematic illustration of convection cooling in accordance with disclosed embodiments.

FIG. 13 is a schematic illustration of a heat pipe in accordance with disclosed embodiments.

FIG. 14 is a schematic illustration of a gravity heat pipe in accordance with disclosed embodiments.

FIG. 15 is a schematic illustration of a liquid trap diode heat pipe in accordance with disclosed embodiments.

FIG. 16 is a schematic illustration of a vapor trap diode heat pipe in accordance with disclosed embodiments.

FIGS. 17A-B are examples of a smart label 122 in accordance with disclosed embodiments.

FIG. 18 is an example of a smart label temperature readings and logs in accordance with disclosed embodiments.

FIG. 19 is an example of BLIS technology incorporated into shelving in accordance with disclosed embodiments.

FIGS. 20A-C are examples of BLIS technology incorporated into larger sized precise temperature-controlled storage devices in accordance with disclosed embodiments.

FIG. 21 is a schematic example of a controller in accordance with disclosed embodiments.

FIGS. 22A-C are exemplary systems and methods for controlling a thermal bridge in accordance with disclosed embodiments.

FIGS. 23A-B are, respectively, isometric and top views of an example of BLIS technology in a single biologic bag embodiment in accordance with the disclosure.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

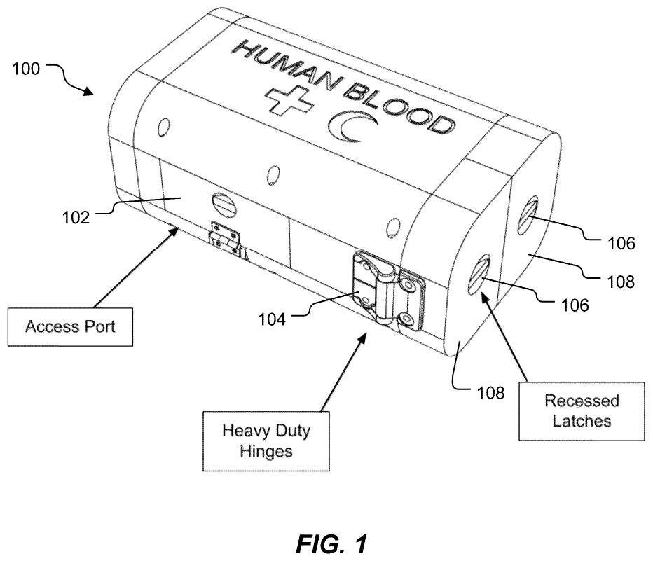

FIG. 1 shows a schematic perspective view of a precise temperature-controlled storage device 100, which comprises an access port 102, heavy duty hinges 104, and recessed latches 106 and lid portions 108 in the closed position.

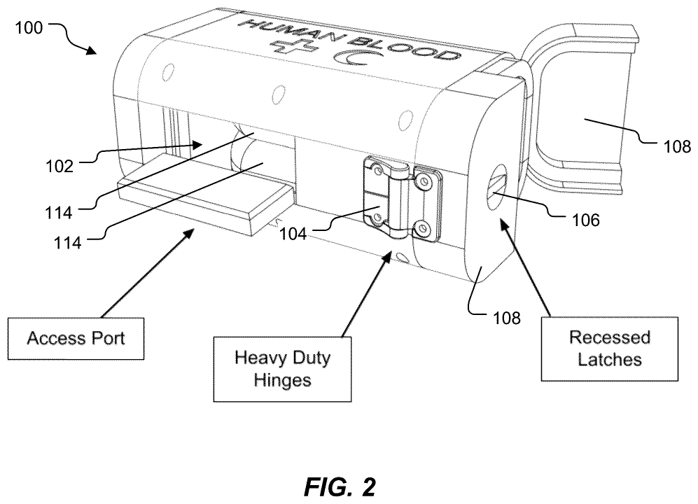

FIG. 2 shows a schematic perspective view of the precise temperature-controlled storage device 100 of FIG. 1 with access port 102 open and one of the lid portions 108 in an open position. Visible through access port 102 are two (2) biologic bags 114 (e.g., smart blood bags or SBB as disclosed herein).

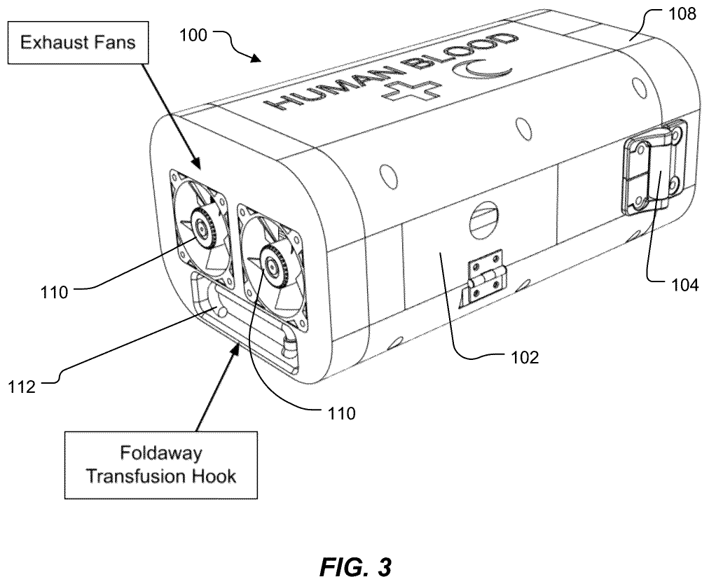

FIG. 3 shows a schematic perspective view of a precise temperature-controlled storage device 100 of FIG. 1 showing an exhaust side comprising exhaust fans 110 and a foldaway transfusion hook. 112.

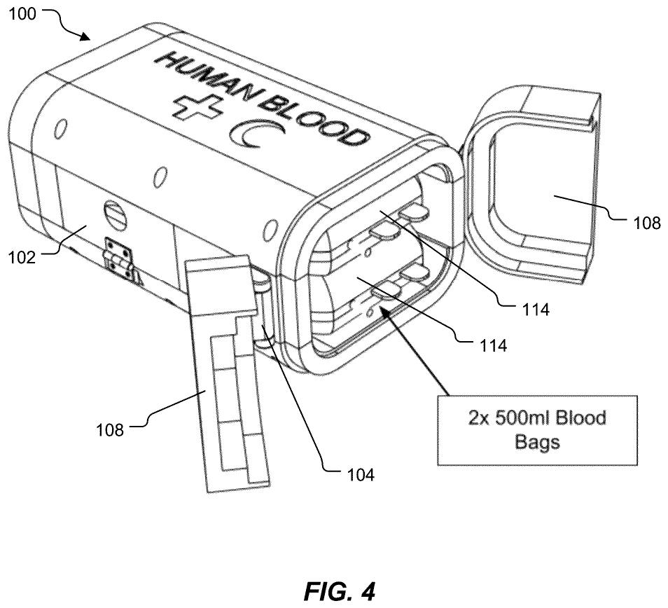

FIG. 4 shows a schematic perspective view of a precise temperature-controlled storage device 100 of FIG. 1 showing an interior contents in the form of two biologic bags 114 which may comprise 500 ml blood bags (for instance smart blood bags as disclosed herein).

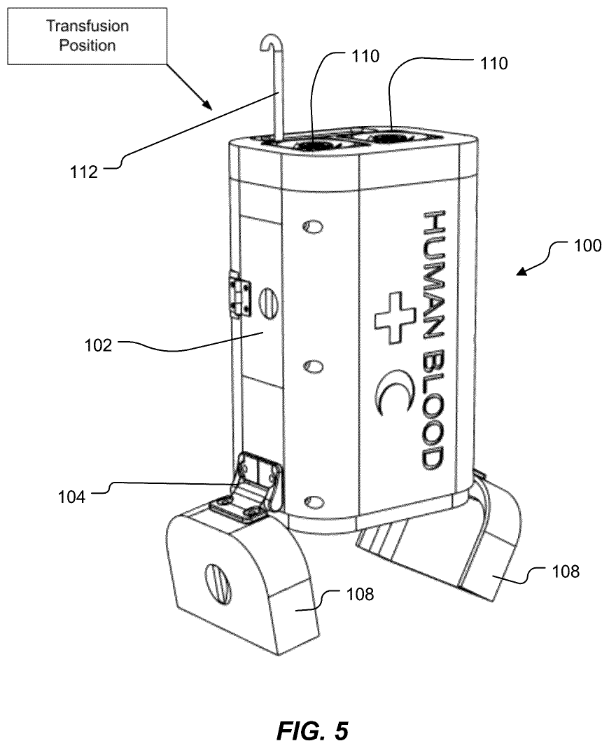

FIG. 5 shows a schematic perspective view of a precise temperature-controlled storage device 100 of FIG. 1 shown in a transfusion position (i.e., with transfusion hook 112 unfolded and available to hook onto an intravenous pole or other stand (not shown) and lid portions 108 open).

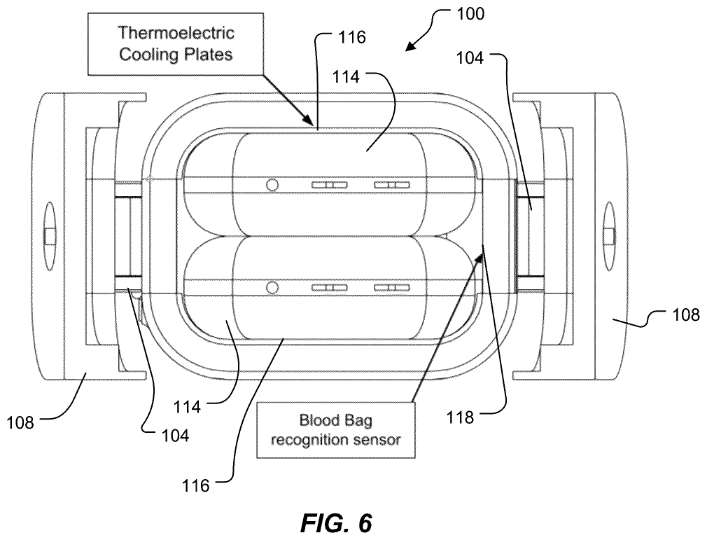

FIG. 6 shows a plan view of a precise temperature-controlled storage device 100 of FIG. 1 comprising thermoelectric cooling plates 116 and a biologic (e.g., blood bag) recognition sensor 118.

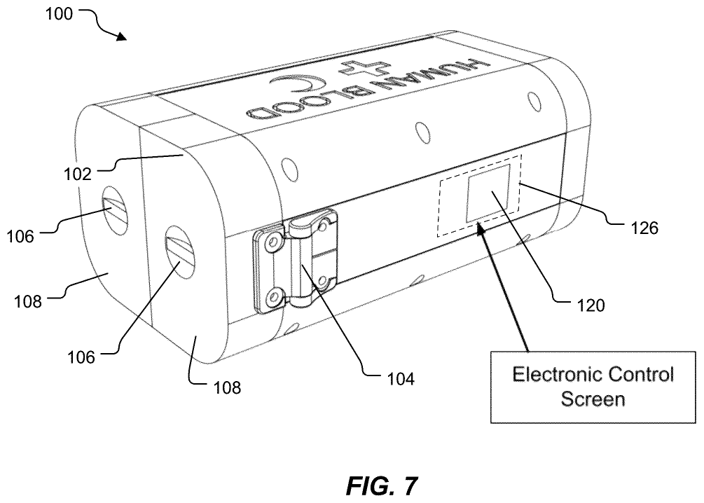

FIG. 7 shows a schematic perspective view of a precise temperature-controlled storage device 100 of FIG. 1, which comprises an electronic control screen 120. Also illustrated schematically is controller circuit 126 which is configured to perform the control functions disclosed herein and may provide inputs/outputs via control screen 120.

FIG. 8 shows a schematic perspective view of a biologic bag 114 (e.g., a smart blood bag) which comprises a smart-label 122 and embodiments may include removable stickers or pull tabs 148 as disclosed herein.

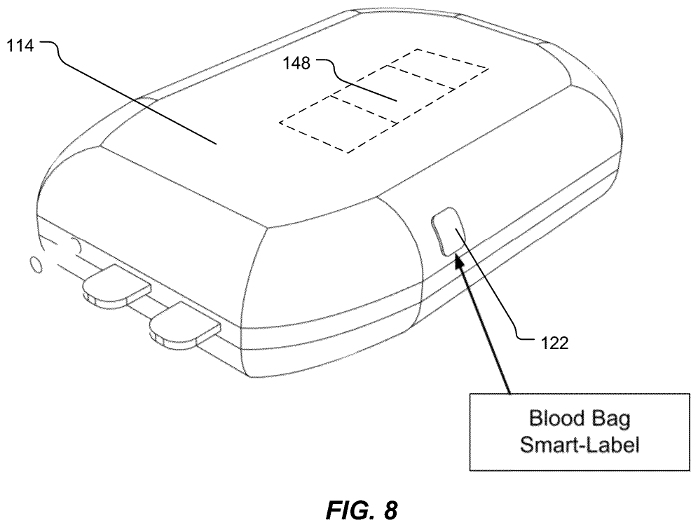

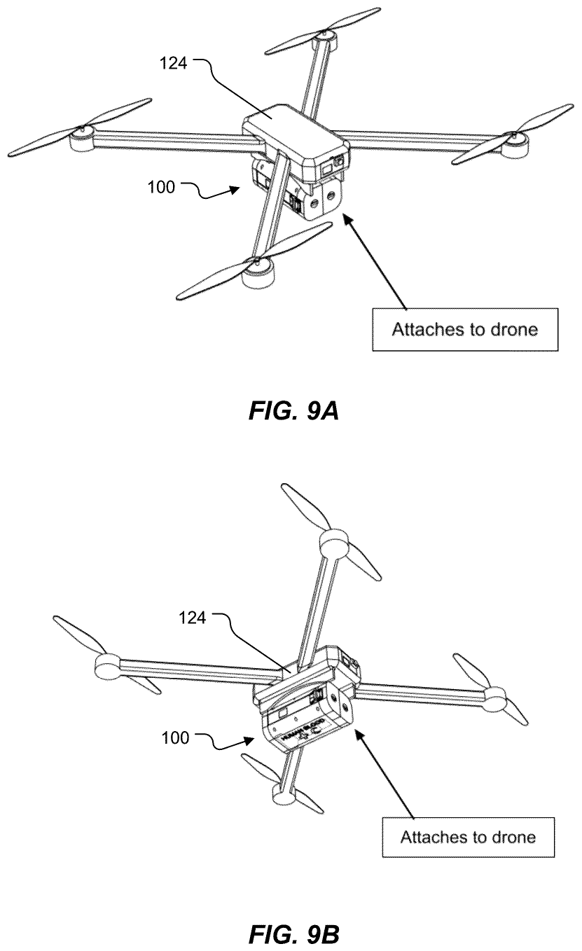

FIG. 9A shows a schematic top perspective view of an assembly of a precise temperature-controlled storage device 100 of FIG. 1 and a drone or UAV 124, in which the precise temperature-controlled storage device 100 is attached to or disposed on the drone 124 for delivery.

FIG. 9B shows a schematic bottom perspective view of an assembly of a precise temperature-controlled storage device 100 and a drone 124 of FIG. 9A, in which the precise temperature-controlled storage device 100 is attached to or disposed on the drone 124 for delivery.

Exemplary Mode of operation with reference to FIGS. 1-9B. In some embodiments, blood or other biologic is drawn into a biologic bag 114 (e.g., a Smart Blood Bag (SBB)). Biologic bag 114 (e.g., an SBB) is equipped with a smart label 122 which, in some embodiments, may comprise an electronic programmable Near Field Communication (NFC) capable label that has a temperature sensor for temperature tracking and has the ability to store electronically readable data such as history from the sensor, time, location, and user input data. NFC is the technology that allows two electronic devices—such as a phone and a payment terminal for instance—to communicate with each other when they are close together. NFC is a short distance (typically <1 cm), low-power, 13.56 MHz wireless technology.

In some embodiments biologic bag 114 (e.g., an SBB) is a blood bag enabled with a smart label 122. Smart labels 122 may be printed and attached to (disposed on) the biologic bags 114 before they are needed for use. Embodiments of smart labels 122 include, but are not limited to, easily readable unique bag serial number, a bar code or QR code with the unique number, and NFC Temperature sensors with embedded serial number matching the bag 114. In some embodiments NFC provides the serialization number to a smart label 122 printer when labels 122 are printed.

In some embodiments, when blood is drawn, smart label 122 is capable of being scanned with a cell phone or similar device with smart capabilities. Input fields are provided on the phone that program user information into the smart label 122 permanent memory, and input fields may be programmed to record information without user input such as time, date and location reported by the cell phone, and written notes can be made on the label 122 if desirable/required. Each time the label 122 is scanned, it records and stores the temperature of the blood or biologic contained within the bag 114. This is real-time data.

In some embodiments, the biologic bag 114 (e.g., an SBB) is placed in the precise temperature-controlled storage device 100 and may be attached to delivery drone or UAV 124 (such as a commercial UAV, a military UAV, or a proprietary drone such as ThermoDrone). The precise temperature-controlled storage device 100 contains the biologic bag(s) 114. As noted herein, an NFC reader can be integrated into the precise temperature-controlled storage device 100. The NFC reader pings (communicates with by sending a signal to) the smart label 122 on the biologic bag 114 (e.g., an SBB) in the precise temperature-controlled storage device 100 on a schedule defined by the user. The pings enable the biologic bag 114 (e.g., SBB) to create a thermal history during transport. The NFC integrated precise temperature-controlled storage device 100 may encase the NFC reader and biologic bag(s) 114 (e.g., SBB(s)) to eliminate possibility of any 13.56 MHz wireless signals outside of the precise temperature-controlled storage device 100 which could otherwise disrupt or the intercept the signal. NFC data from the biologic bag 114 (e.g., SBB) may be integrated into the UAV 124 and transmitted through the drone communication channel or used by the UAV 124 to adjust temperature.

As will be apparent, UAV 124 is capable of transporting the precise temperature-controlled storage device 100 and enclosed biologic bags 114 (e.g., SBB) to a desired location. Temperature can be adjusted by the precise temperature-controlled storage device 100 during transit.

In some embodiments, when biologic bag 114 (e.g., SBB) is removed from precise temperature-controlled storage device 100 the smart label 122 can be read by a cell phone or similar reader. Origination and temperature history can thus be transferred from the smart label 122 to the reader. The smart label 122 continues to provide current (real-time) temperature and updated history each time it is read. In some embodiments, cell phone type readers can upload all smart label 122 history to a cloud server (such as that of the Department of Defense) when access is available.

In some embodiments, biologic bag 114 (e.g., SBB) temperature data may be used to verify an acceptable temperature range for use of the biologic (e.g., blood). Likewise, the temperature history data may be viewed to verify the quality of the biologic (e.g., blood).

In some embodiments, biologic bag 114 and/or smart label 122 may include pull tab or other removable portion 148 with a bar code that may be adhered to a patient. For example, the presence of a pull tab 148 on a patient indicates use of at least one biologic bag 114 (e.g., a unit of blood or other biologic has been administered) and the presence of multiple tabs 148 on a patient indicates multiple units have been administered. In some embodiments the reader (e.g., smartphone or the like) may input smart label 122 data into a prescribed cloud folder and may also include patient ID and the like.

In some embodiments, biologic bag 114 and/or smart label 122 data may be used to facilitate patient transport to a care center. For example, a care giver has access to all blood or other biologic history by scanning the smart label 122 bar code (or QR code, or the like) and even if smart label 122 data is not available, the biologic bag 144 history is available linked to patient ID in the cloud.

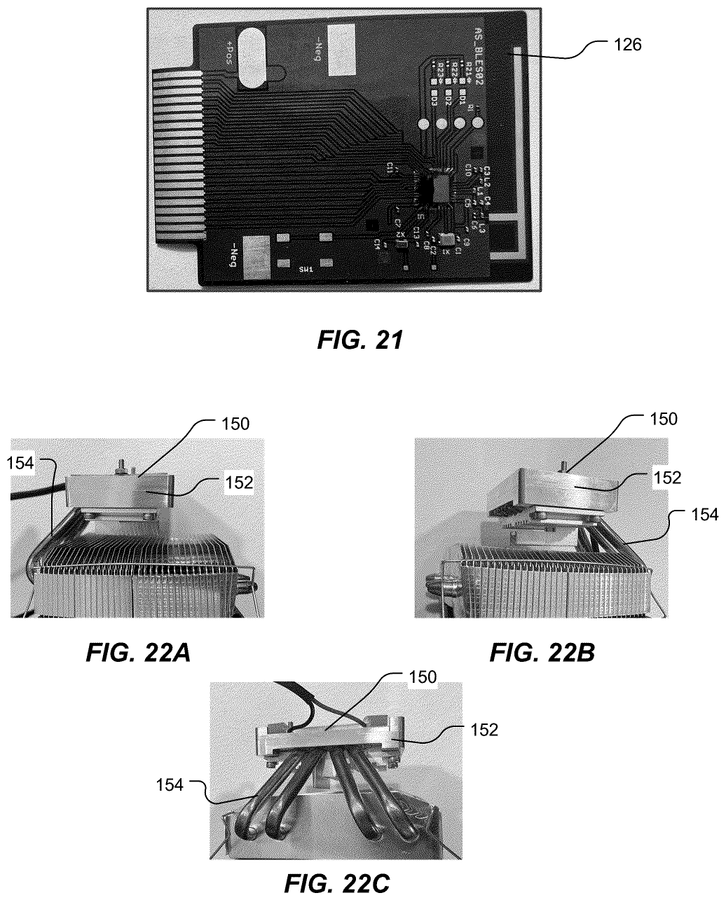

Embodiments of the controller 126 may utilize Near-field Communication (NFC) Technology/NFC Tags embedded into biologic bags 114 or into standard whole blood bags with smart labels 122 to feed into the device 100 algorithm to maintain and log temperature throughout, for example, a 28-day lifespan of each unit of blood or other biologic. Temperature readings may be taken more or less frequently as needed to keep the precise temperature-controlled device 100 at a desired storage temperature. FIG. 21 is a schematic example of a controller 126, in this example a flexible micro-component read/write chipset that may be incorporated into embodiments of precise temperature-controlled storage device 100.

According to disclosed embodiments, there is provided a precise temperature-controlled storage device 100 that is capable of monitoring, regulating, and/or adjusting the temperature of content(s) (e.g., biologic bags 114) stored therein. The device 100 is operable to store content(s) (e.g., biologic bags 114) comprising a smart label 122. The device 100 comprising either a dedicated electronic reader or a smartphone, tablet, or device with smart capabilities, or the like operable to read data from the smart label 122, and capable of adjusting the temperature of the content(s) (114) in response to data received from the smart label 122 to a target temperature, and capable of transmitting the data to a smart device.

The precise temperature-controlled storage device 100 and drone 124 may be integrated to allow efficient management of power consumption for delivery/transit and temperature control of the contents (e.g., 114) of the device.

As disclosed herein, embodiments of precise temperature-controlled storage device 100 may implement thermoelectric coolers (TEC) 116. Thermoelectric coolers 116 operate according to the Peltier effect. The effect creates a temperature difference by transferring heat between two electrical junctions. A voltage is applied across joined conductors to create an electric current. When the current flows through the junctions of the two conductors, heat is removed at one junction and cooling occurs. Heat is deposited at the other junction.

It is generally understood that the main application of the Peltier effect is cooling. However, the Peltier effect can also be used for heating or control of temperature. In most cases, a DC voltage is required.

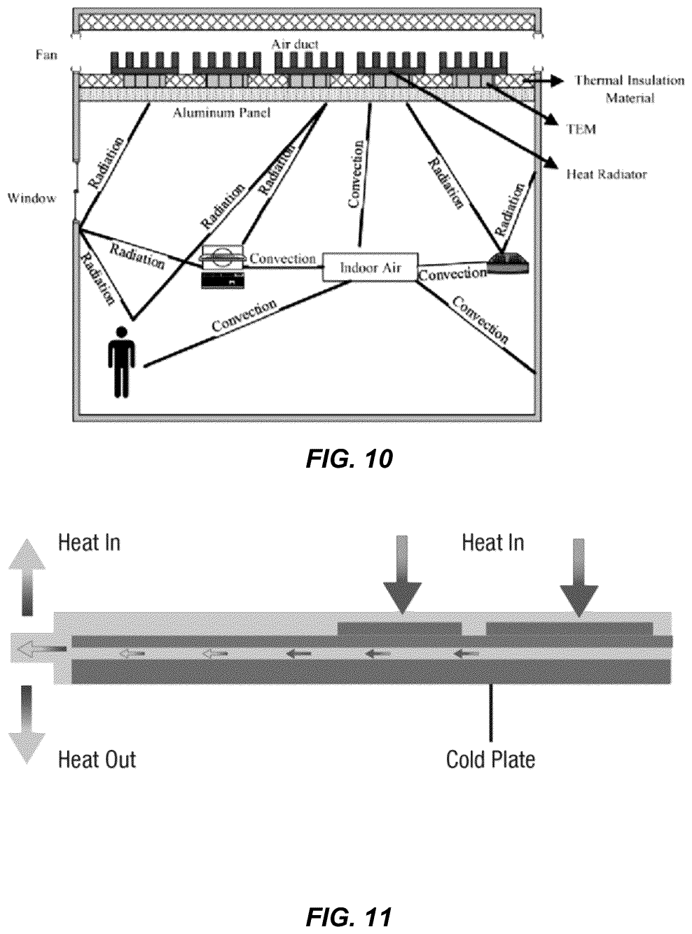

Generally, there are three ways to maximize cooling: radiant forced air, conduction, and convection. Compared to a traditional forced-air system, radiant cooling has a lower operating cost due to the superior heat transfer properties of water. The installation of a radiant cooling system may also lead to a significant reduction in forced-air system components and ductwork costs. For example, forced-air cooling is accomplished by exposing packages of produce in a cooling room to higher air pressure on one side than on the other. This pressure difference forces the cool air through the packages and past the produce, where it picks up heat, greatly increasing the rate of heat transfer. An example of this is shown in FIG. 10.

Conduction cooling is defined as the transfer of heat through solids. A common example of this is the conduction-cooled chassis mounted onto a cold plate. Heat generated inside the chassis by the electronics flows into the chassis aluminum sidewalls and down into the cold plate. An example of this is shown in FIG. 11.

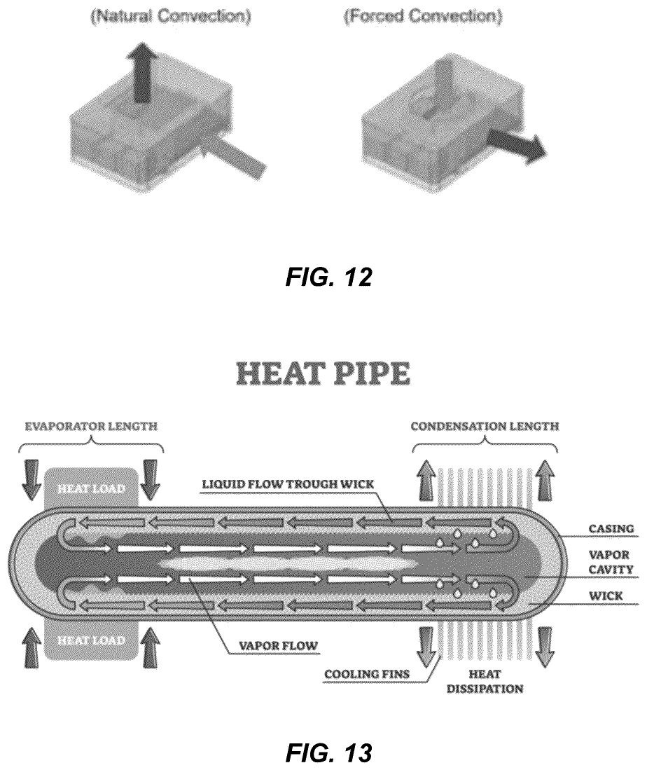

Convection cooling is the mechanism where heat is transferred from the hot device by the flow of the fluid surrounding the object. The fluid can cool either air, which is the most common, or another suitable liquid. During the cooling process the heat causes an expansion of the fluid and a reduction in its density. An example of this is shown in FIG. 12.

Heat Pipes are heat dissipation components that are capable of transferring heat from one location to another relatively quickly by utilizing the phenomenon of thermal energy (latent heat) being absorbed when a liquid changes state into a gas and being released when a gas changes state into a liquid. Standard heat pipes will transfer heat equally in both directions. If the nominal condenser is hotter than the evaporator, then heat will flow in reverse, from the “condenser” to the “evaporator”. An example of this is shown in FIG. 13.

There are at least two ways to control the reverse movement of heat, which are referred to in this specification as “break[ing] the thermal bridge.” Two of the ways to break the thermal bridge are: Gravity Controlled Heat Pipes and Diode Controlled Heat Pipes.

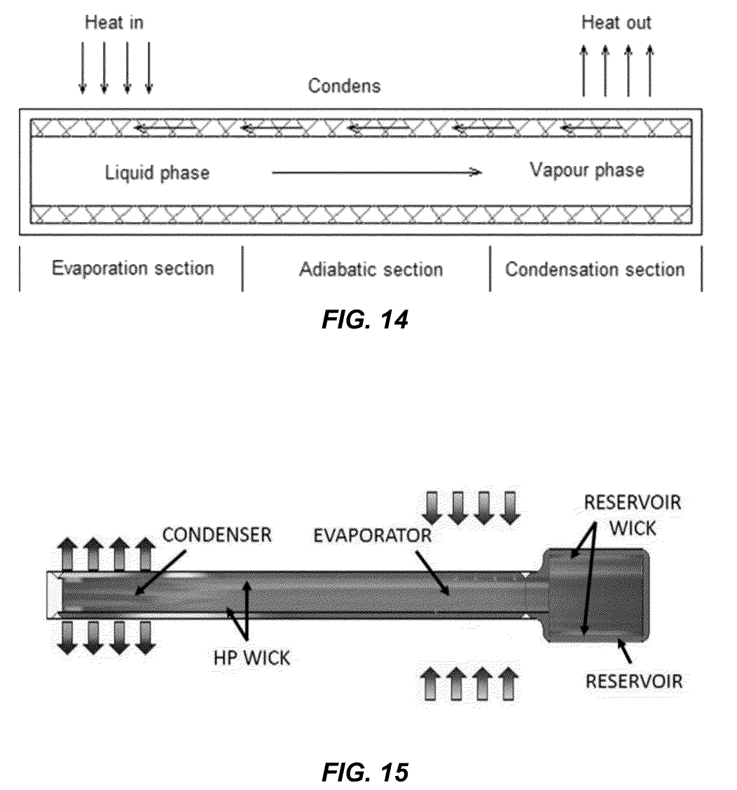

Gravity controlled heat pipes break the thermal bridge in one way and do not allow for the option of moving heat back and forth through the system. See, for example, https://www.intechopen.com/chapters/57535. “Gravity in Heat Pipe Technology,” written by Patrik Nemec, Submitted: 7 Apr. 2017 Reviewed: 9 Oct. 2017 Published: 20 Dec. 2017, DOI: 10.5772/intechopen.71543, which is incorporated herein in its entirety by reference. An example of this is shown in FIG. 14 which discloses the principle of heat pipe.

Diode controlled heat pipes are designed to do the same work as gravity controlled heat pipes in environments where gravity does not exist. Note that a thermosyphon will also act as a diode heat pipe (the thermosyphon condenser is typically wickless, so liquid is not supplied to the nominal condenser). There are two basic types of diode heat pipes: Liquid Trap Diodes and Vapor Trap Diodes:

Embodiments of a liquid trap diode have a wicked reservoir located at the evaporator end of the diode heat pipe. The wicks in the heat pipe and reservoir are designed so that they cannot communicate with each other. During normal operation, the heat pipe behaves like a standard heat pipe. Heat applied to the evaporator and reservoir causes liquid to evaporate. The vapor travels to the condenser and capillary action in the heat pipe wick returns the condensate to the evaporator. Since the reservoir wick is not connected to the main wick, the reservoir quickly dries out and becomes inactive. When the condenser becomes hotter than the evaporator/reservoir, the role of the evaporator and condenser are switched. Vapor evaporates from the hotter nominal condenser and travels to the nominal evaporator and the reservoir, where it condenses. Since the reservoir wick does not communicate with the heat pipe wick, any liquid that condenses in the reservoir cannot return to the nominal condenser. In a short time, all of the liquid is trapped in the reservoir. The main part of the pipe contains only vapor, so the only heat transfer from the condenser to the evaporator is by conduction through the heat pipe wall and wick, which has a much higher thermal resistance than the resistance during normal operation. As soon as the evaporator and reservoir become hotter than the condenser, the liquid evaporates from the reservoir and the heat pipe resumes normal operation. An example of this is shown in FIG. 15.

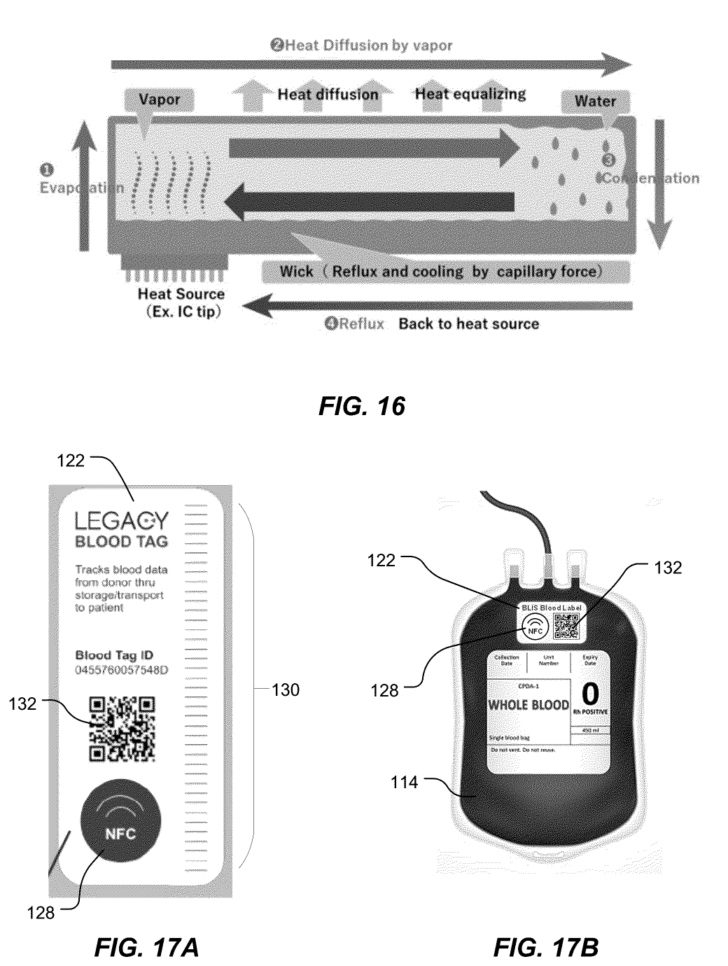

Embodiments of a vapor trap diode include those in which a vapor chamber is a planar heat pipe, which can spread heat in two dimensions, using its entire body to cool the heat source. Its flat structure allows heat to be transferred evenly through a very small space. A vapor chamber can be contemplated as a flat heat pipe in such a sense. An example of this is shown in FIG. 16.

Heat is always working toward achieving temperature equilibrium. When deploying a TEC-based device and powering it on with DC voltage, one side of the TEC chip gets hot and the other side of the TEC chip gets cold. Once power is turned off, heat moves from the hot side of the TEC chip to the cold side of the TEC chip to achieve temperature equilibrium. This may be undesirable when cooling as it quickly dissipates the cooling (cold plate) side of the device.

According to disclosed embodiments, efficiencies are gained by including heat pipes and heat sinks to the hot side of the TEC plates 116 and a medium/method to take advantage of utilizing the cold side of the chip to cool or maintain a temperature of a liquid or solid.

For example, embodiments may employ a heat pipe gating system that allows heat to move both ways through the heat pipe as desired. Electronic or Pneumatic powered gates open and close depending on the work that is desired (the direction in which moving heat is desired). The system can size from an ultra-thin microchip size to computer heat pipe/heat sink cooling to large industrial applications. Gates open and close based on commands that control the system (e.g., from controller 126). These gates allow for heat to flow freely in the path that is opened up (in communication).

The ability to control the flow of heat once the power to the TEC 116 is turned off allows the cold side of the TEC 116 to remain colder than if it were suddenly inundated with the Delta T heat on the hot side of the chip. Rather than moving that heat back into the Cold side of the TEC 116, in some embodiments it may be desirable to offload that heat via a heat pipe gating system (e.g., as shown in FIG. 15-16 and FIG. 22A-C) to maintain the temperature of the thing that is being cooled (e.g., biologic bag 114).

FIGS. 22A-C are exemplary systems and methods for controlling a thermal bridge in accordance with disclosed embodiments. FIG. 22A is a left side view, FIG. 22B is a right side view, and FIG. 22C is a rear side view. According to disclosed embodiments, there an ultra-thin thermoelectric device 150 (e.g., Peltier chipset) has the following functionality. A cold side and a hot side of a thermoelectric design with an electronic, pneumatic, or other gate controller 152 such that when cooling is desired, or maintaining a cold state of a liquid, for example, the cold side could be powered on and powered off without heat flowing from warmer to colder as is the case with traditional thermoelectric designs.

According to disclosed embodiments an ultra-thin, lightweight thermoelectric (TEC) 150 includes a form-fitting slip cover 152 with heat pipe gating system 152, 154 in thermoelectric cooling for temperature-sensitive applications, including blood, as disclosed herein.

Typically, 1 unit of low-titer O+ whole blood weighs approximately 1 lb. (approximately 450-500 ml) (e.g., biologic bag 114). As disclosed herein when biologic bag 114 is enclosed form fitting ultra-thin, Lightweight Thermoelectric (TEC) 150 form fitting slip cover 152 with a built-in heat pipe gating system 154 creates the ability to keep that unit of blood at storage temperature (1-6° C.) and then warm it to ˜ 38° C. for transfusion. The ability to stay in these desired temperature ranges is largely regardless of ambient temperature. Based on cooling and storage requirements, among other things, unit 100 may be powered by something as readily available as a standard commercial battery [A, AA, AAA, AAAA, 9V, etc.] or other suitable DC power source.

According to some embodiments, a blood collection and storage bag (e.g., biologic bag 114) with an ultra-thin, lightweight thermoelectric (TEC) 150 technology built into the bag 114 itself and includes a heat pipe gating system 154 between the cold side and hot side of the TEC 116. This system may encompass the entirety of the bag 114 and may be powered by connecting a standard commercial battery [A, AA, AAA, AAAA, 9V, etc.] or other suitable DC power source. All of the component parts can be thin layers designed into the bag 114 itself.

As will be apparent to those of ordinary skill in the art having the benefit of this disclosure, the disclosed designs have additional non-blood related uses in medical, industrial and other applications.

In some embodiments, the disclosed BLIS systems and methods are a purpose-built ecosystem that upgrades the blood and biologic supply chain, integrating cutting-edge technologies to ensure verifiable temperature control and maintain blood integrity from donor to recipient. The system addresses dual-use needs for military and civilian applications, aiming to streamline logistics, conserve blood resources, and establish a robust data chain for research and planning. As disclosed herein, BLIS systems and methods utilize the aspects discussed herein with regard to an ultra-thin thermoelectric device (e.g., Peltier chipset) 150, an ultra-thin, lightweight thermoelectric (TEC) form-fitting slip cover 152 with heat pipe gating system 154 in thermoelectric cooling for temperature-sensitive applications, and a blood collection and storage bag 114 with an ultra-thin, lightweight thermoelectric (TEC) 150 technology built into the bag 114 itself and includes a heat pipe gating system 152, 154 between the cold side and hot side of the TEC 116, for instance.

Disclosed embodiments create a complete blood logistics integrity and security program that modernize existing practices and procedures, ensure cybersecurity of the blood cold chain, along with providing data and tracking from donor to recipient and extended shelf-life of blood products is thus enabled.

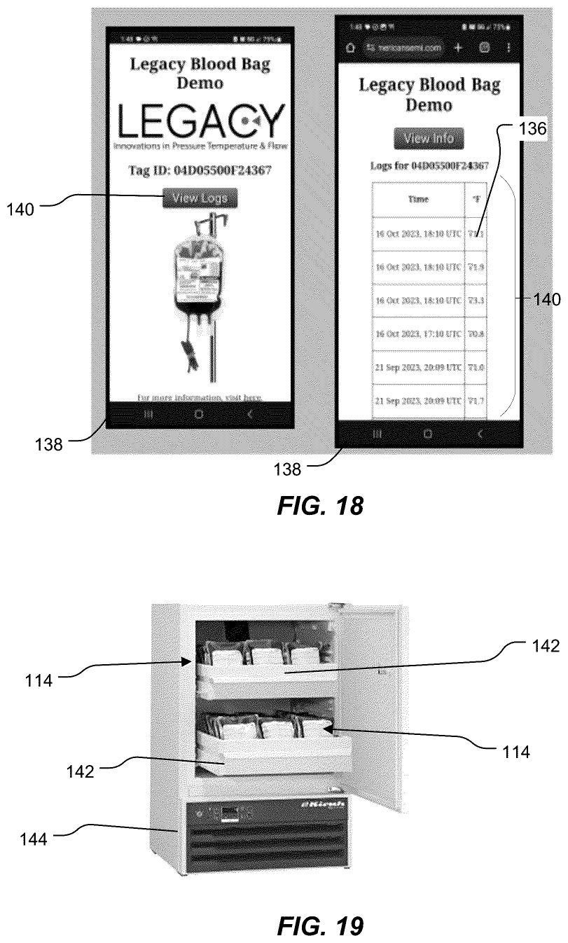

FIGS. 17A-B are examples of a smart label 122 in accordance with disclosed embodiments. Embodiments of smart label 122 may comprise an adhesive label with an embedded Near-Field Communication (NFC) chip 128 with thin, flexible sensors 130 and a companion QR code 132. Embodiments of smart label 122 may be adhered to the blood bag 114 on the opposite side of the traditional blood label 134 or at other locations on a biologic bag 114 as shown in FIG. 17B. As disclosed herein, smart label 122 may also include pull tabs or other removable portions 148 (see FIG. 8) that may be adhered to a patient during use. It accurately monitors blood temperature to 1/100th of a degree Celsius in a predefined temperature range. Embodiments of flexible sensors 130 in smart label 122 take temperature readings 136 (which may be read using a standard mobile device 138—see, e.g., FIG. 18—or other standalone reader device) and securely logs 140 data every minute for the entire 28-day shelf-life of whole blood. This ensures precise and continuous temperature monitoring without interfering with existing labels on the blood bag. Other information, such as the donor's identifier (e.g., a barcode or the like for standard practice) is written to the NFC chip 128 to track from donor source to blood recipient.

FIG. 19 is an example of BLIS technology incorporated into shelving 142 in accordance with disclosed embodiments. Typically, blood is collected and then stored in a blood bank. Blood bank refrigeration systems typically are not sold with shelving (which is purchased separately). Therefore, 3D printed racks 142 equipped with BLIS technology exists an opportunity to replace typical blood bank shelving with, which makes it possible to track ongoingly the temperature of every BLIS tagged unit of blood 114 on every BLIS blood bank rack. The 3D printed racks 142 are designed to seamlessly fit into existing refrigeration systems, as they are exact replicas of the original shelves with added tracking technology. Each stored blood bag 114 has data written to it every minute including temperature and location, or as frequent as every 2 seconds if needed. An external device connected 144 to the racks oversees blood storage, recording metrics like duration in storage and any instances where the temperature exceeded 6° C. If such an event occurs, it signals that the stored blood must be used within 8 hours.

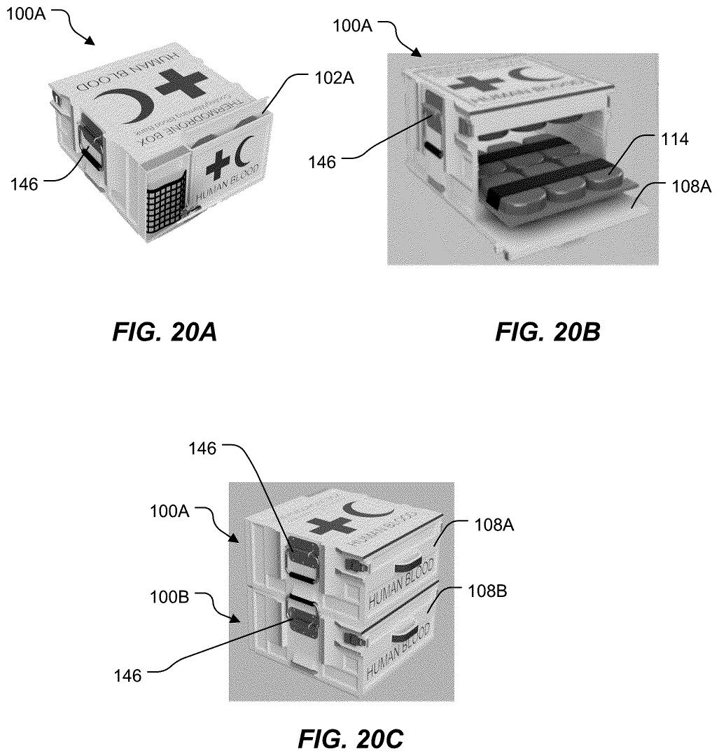

FIGS. 20A-C are examples of BLIS technology incorporated into larger sized precise temperature-controlled storage devices in accordance with disclosed embodiments. As disclosed in connection with FIGS. 1-9B above, the herein disclosed systems and methods can be scaled to larger sizes as desired. For example, FIG. 20A shows a larger precise temperature-controlled storage device 100A having an access port 102A and one or more handles 146. Embodiments of storage device 100A may be size to hold, for example, 12 biologic bags 114 as best seen in FIG. 20B where lid 108A is open. As illustrated in FIG. 20C embodiments of larger sized storage devices 100A, 100B may be stackable and interlock using handles 146 or other appropriate interconnects. Such embodiments facilitate, among other things, easier transport of large volumes of biologic bags 114.

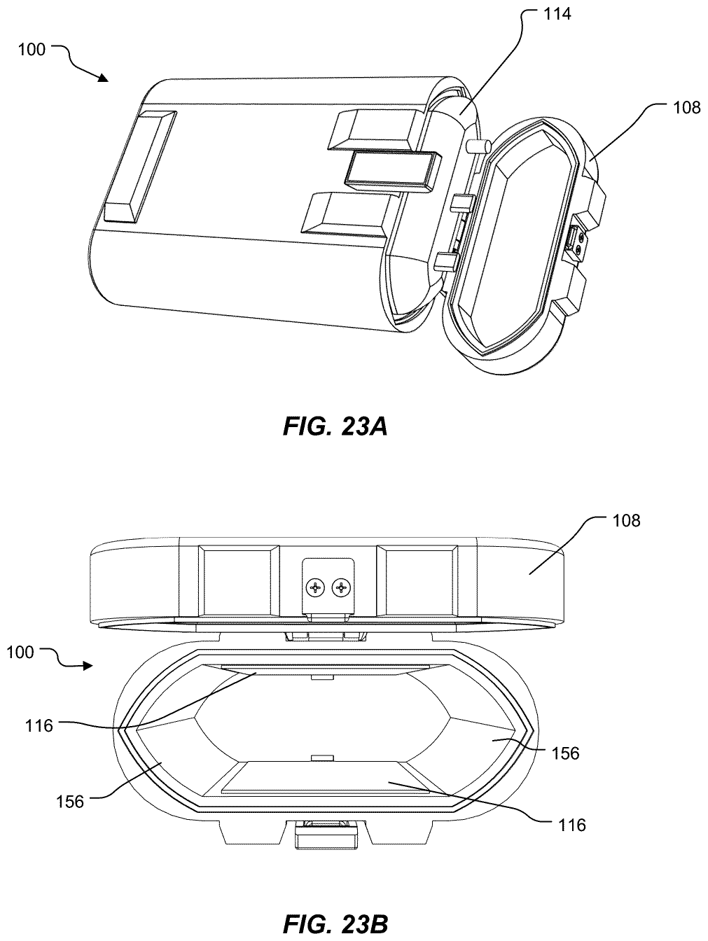

FIGS. 23A-B are, respectively, isometric and top views of an example of BLIS technology in a single biologic bag 114 embodiment in accordance with the disclosure. As shown in FIG. 23A, embodiments of precise temperature-controlled storage device 100 may be sized to contain a single biologic bag 114. One advantage of such an embodiment is the comparatively light weight and small size make the temperature-controlled biologic easier to transport. For example, a single bag embodiment may be attached to a smaller UAV 124, or even thrown by hand, to transport short distances where needed.

As shown in FIG. 23B, with biologic bag 114 removed for clarity, the interior of these embodiments may include thermoelectric cooling/heating plates 116 as well as a variable durometer layer lining 156. Among other things, variable durometer layer lining 156 may comprise layers of materials of varying elasticity and durometer values that are biased or otherwise configured to contract or expand towards the center of the interior portion of the precise temperature-controlled storage device 100. Among other things, this enables the biologic stored in the biologic bag 114 to be protected during transport and also “squeezed” upon dispensing during a transfusion or the like. Thus, the precise temperature-controlled storage device 100 and biologic bag 114 within do not need to be suspended (i.e., employ gravity) in order to dispense the biologic (e.g., blood) within. This enables, among other things, the warming of the biologic (e.g., blood) during transport and immediate (e.g., “on the field”) use of the same without the need for poles or other suspension devices.

Although various embodiments have been shown and described, the present disclosure is not so limited and will be understood to include all such modifications and variations would be apparent to one skilled in the art.

What is claimed is:

1. A system for temperature-controlled biologics storage, delivery, integrity, and security, the system comprising:
a temperature-controlled storage device comprising:
a lid portion configured to securely close the temperature-controlled storage device when closed and provide access to an interior portion of the temperature-controlled storage device when opened;
a thermoelectric cooling plate; and
a biologic bag sensor;
a biologic bag configured to selectively store and dispense a biologic substance; and
a smart label comprising:
a tunable temperature sensor;
a read-write recorder capable of delivering power to the tunable temperature sensor and configured to acquire temperature readings from the biologic bag and maintain a data log; and
wherein the temperature-controlled storage device is configured to adjust the temperature of the thermoelectric cooling plate based on communication from the tunable temperature sensor.

2. The system of claim 1 further comprising a communications device to send data from the data log to a storage device located external to the temperature-controlled storage device.

3. The system of claim 2 wherein the communications device comprises near field communications (NFC) apparatus.

4. The system of claim 1 wherein the smart label further comprises a machine-readable portion providing access to the data log.

5. The system of claim 4 wherein the machine-readable portion comprises a quick response (QR) code.

6. The system of claim 1 wherein the smart label further comprises removable portions that are attachable to a patient upon dispensing of the biologic substance.

7. The system of claim 1 wherein the temperature-controlled storage device is configured to be attachable to an unmanned aerial vehicle.

8. The system of claim 1 wherein the temperature-controlled storage device comprises one or more shelves.

9. The system of claim 1 wherein the temperature-controlled storage device comprises an interior portion configured to contain up to two 500 ml biologic bags.

10. The system of claim 1 wherein the temperature-controlled storage device comprises an interior portion configured to contain up to twelve 500 ml biologic bags.

11. A system for controlling a thermal bridge comprising:
a thermoelectric cooling element;
an active gate heat pipe controller; and
at least one heat pipe.

12. A method for temperature-controlled biologics storage, delivery, integrity, and security, the method comprising:
controlling a temperature of a temperature-controlled storage device containing a biologic bag configured to selectively store and dispense a biologic substance; and
communicating from a smart label on the biologic bag, the smart label comprising:
a tunable temperature sensor; and
a read-write recorder capable of delivering power to the tunable temperature sensor and configured to acquire temperature readings from the biologic bag and maintain a data log; and
adjusting the temperature of the temperature-controlled storage device based on communication from the tunable temperature sensor.
